(19) United States
(12) Patent Application Publication
(10) Pub. No.: US 2026/0029554 A1
(43) Pub. Date: Jan. 29, 2026

(54) METHOD AND SYSTEM FOR POSITIONING A TRAJECTORY OF AN ULTRASONIC LOGGING TOOL

(71) Applicant: University of Electronic Science and Technology of China, Chengdu, Sichuan Province (CN)

(72) Inventors: Hua WANG, Chengdu (CN); ShaoPeng SHI, Chengdu (CN); Shengya LI, Chengdu (CN); ZhiLong FANG, Chengdu (CN); Qiang WANG, Chengdu (CN)

(21) Appl. No.: 19/169,212

(22) Filed: Apr. 3, 2025

(30) Foreign Application Priority Data
Apr. 23, 2024 (CN) 202410493060.5

(51) Int. Cl. G01V 1/50; E21B 47/024

(52) U.S. Cl. CPC G01V 1/50; E21B 47/024; G01V 2210/6222; G01V 2210/67

(57) ABSTRACT

A method and system for positioning a trajectory of an ultrasonic logging tool includes steps: S1: inputting waveforms and extracting arrival times; S2: establishing a coordinate system and initializing a tool trajectory; S3: calculating an initial wave velocity in fluid using a least squares method, and calculating a distance between the tool and a casing and coordinates of casing's inner surface based on the initial wave velocity in fluid and time; S4: searching for an optimal tool trajectory based on the distance and the inner boundary coordinates, and updating a wave velocity in fluid based on a perimeter of the inner boundary; S5: repeating steps S3 and S4 until the update amount of the tool trajectory between two iterations is less than a threshold; S6: outputting a final tool trajectory, wave velocity in fluid and casing's inner surface.

### FIELD

The present invention relates to the technical field of fluid-filled pipe string measurement, and more particularly, to a method and system for positioning a trajectory of an ultrasonic logging tool.

### BACKGROUND

Fluid-filled pipe strings (such as oil well casings, oil and gas pipelines, water supply and drainage pipelines, and chemical pipelines) serve as industrial installations used for transporting various liquids and play a crucial role in multiple industries. Influenced by factors such as the properties of the internal fluid, external environmental conditions, installation, and the aging of the pipe strings, these fluid-filled pipe strings are prone to deformation, corrosion, and wear, which may pose risks to operational safety. Therefore, it is necessary to conduct periodic inspections of irregular fluid-filled pipe strings, particularly those in extreme environments (such as underground, subsea, high-temperature, and high-pressure conditions), to ensure system safety and reliable operation. However, the actual measurement environment is complex, and multiple factors such as pipe string deformation, the self-weight of tools, improper use of centralizers, and variations in internal fluid properties can make it difficult for the measurement tools to operate under ideal conditions, thereby reducing inspection accuracy. The present disclosure takes ultrasonic logging in cased wells as an example to illustrate the aforementioned issues and to explore the inversion methods for geometric parameters (shape and position) and fluid acoustic velocity in irregular fluid-filled pipe string models.

Ultrasonic measurement is a commonly used method for the integrity inspection of fluid-filled pipe strings, particularly oil well casings. By placing an ultrasonic logging tool in the casing, high-frequency acoustic waves are generated, and the reflected waveforms from the casing inner wall are detected to analyze issues such as deformation, corrosion, and defects in the casing. During actual measurements, centralizers are used to ensure the tool is centered. However, improper use of centralizers, the influence of the self-weight of tools in highly deviated or horizontal wells, and irregular deformations of the casing can alter the tool's measurement position, causing it to measure in an eccentric state. This, in turn, affects the arrival time and amplitude of the waveforms received by the tool. Additionally, the wave velocity in fluid, which varies with temperature and pressure, can also impact the measurement waveforms, reducing the effectiveness of the integrity evaluation of fluid-filled pipe strings. The prerequisite for improving the evaluation effectiveness of ultrasonic measurements in the fluid-filled pipe strings is to obtain accurate measurement positions and environmental conditions of the tool, including the tool's eccentric position, the geometric parameters of the fluid-filled pipe strings, and the wave velocity in fluid in the pipe strings.

The most advanced ultrasonic measurement tools for oil well casings currently include two measurement modes: one is the pulse-echo measurement, which emits ultrasonic pulses perpendicular to the casing inner wall and measures the reflected and resonant waves from the casing; the other is the pitch-catch measurement, which utilizes a set of obliquely aligned ultrasonic probes to excite the flexural mode of the casing, thereby acquiring information about the casing external interfaces. These ultrasonic measurement tools are commonly used to evaluate the cementing quality outside the casing. However, there is limited and somewhat inadequate research on algorithms for eccentric positioning and casing's inner surface inversion with this logging tool, failing to fully exploit the advantages of this ultrasonic logging tool.

### SUMMARY

In order to solve the technical problem of effectively evaluating the internal geometric parameters of fluid-filled pipe strings and the wave velocity in fluid, the present invention adopts the following technical solution: a method and system for positioning a trajectory of an ultrasonic logging tool, comprising the following steps:
S1: inputting waveforms and extracting arrival times T;
S2: establishing a coordinate system and initializing a tool trajectory M₀;
S3: calculating an initial wave velocity in fluid Vf₀ using a least squares method, and calculating a distance D between the tool and a casing and coordinates of casing's inner surface No based on the initial wave velocity in fluid Vf₀ and time T;
S4: searching for an optimal tool trajectory M₁ based on the distance D and the inner boundary coordinates N₀, updating a wave velocity in fluid Vf₁ according to a perimeter of the inner boundary N₀, and updating a distance D between the tool and the casing and coordinates of casing's inner surface N₁ based on Vf₁ and time T;
S5: repeating step S4 until the update amount of the tool trajectory between two iterations is less than a threshold;
S6: outputting a final tool trajectory M, wave velocity in fluid V_{f}, and casing's inner surface N.

Further, step S1 comprises the following sub-steps:
S11: inputting a pulse-echo measurement waveform and a pitch-catch measurement waveform;
S12: extracting an arrival time T1 of the primary echo of the pulse-echo and arrival times T21 and T22 of the primary A₀ at near receiver and far receiver, respectively, using a long-short time window algorithm.

Further, step S2 specifically comprises: establishing a Cartesian coordinate system with a casing center as an origin and a 0° measurement azimuth of the pulse-echo as an x-axis, and initializing the tool trajectory M₀ as the coordinate origin.

Further, step S3 comprises the following sub-steps:
S31: establishing a computational model for a propagation distance of the pulse-echo and a propagation distance of the oblique incidence, and solving for the wave velocity in fluid Vf₀ at a current depth using the least squares method;
S32: calculating a distance D₀′ between a pulse-echo sensor and a casing inner wall based on T1 and Vf₀; calculating a distance D₀″ between a pitch-catch sensor and the casing inner wall based on T21, T22 and Vf₀;
S33: calculating the casing's inner surface No based on M₀, D₀′ and D₀″.

Further, step S33 specifically comprises: calculating a casing's inner surface coordinate set N₀′ based on M₀ and D₀′; calculating a casing's inner surface coordinate set N₀″ based on M₀ and D₀″; interpolating N₀′ and N₀″ according to an azimuth angle, respectively, and taking an average of the two boundaries as an estimated casing's inner surface No.

Further, step S4 comprises the following sub-steps:
S41: calculating all possible positions of the tool based on the distance D and the coordinates of casing's inner surface N₀, and searching for the shortest trajectory as the optimal tool trajectory M₁;
S42: updating the wave velocity in fluid Vf₁ based on a perimeter of the inverted casing's inner surface No or a perimeter of an ellipse fitted to No;
S43: calculating a distance D₁′ between the pulse-echo sensor and the casing inner wall based on T1 and V_{f1}; calculating a distance D₁″ between a pitch-catch sensor and the casing inner wall based on T21, T22 and Vf₁; S44: calculating the casing's inner surface N₁ based on M₁, D₁′ and D₁″.

Further, step S44 specifically comprises: calculating a casing's inner surface coordinate set N₁′ based on M₁ and D₁′; calculating a casing's inner surface coordinate set N₁″ based on M₁ and D₁″; interpolating N₁′ and N₁″ according to the azimuth angle, respectively, and taking an average of the two boundaries as an estimated casing's inner surface N₁.

A system for positioning a trajectory of an ultrasonic logging tool, configured to implement the method for positioning the trajectory of the ultrasonic logging tool as above-mentioned, comprising an input module, an initialization module, a calculation module, an optimization module, a determination module, and an output module, wherein:
the input module is configured to input a waveform array and extract a waveform arrival time T;
the initialization module is configured to establish a coordinate system and initialize a tool trajectory M₀;
the calculation module is configured to calculate an initial wave velocity in fluid Vf₀ using a least squares method, and calculate a distance D between the tool and a casing and coordinates of casing's inner surface No based on the initial wave velocity in fluid Vf₀ and time T; the optimization module is configured to, starting from M₀, search for an optimal tool trajectory M₁, and update a wave velocity in fluid Vf₁, a distance D between the tool and the casing, and the coordinates of casing's inner surface N₁ based on a distance between M₁ and N₀; the determination module is configured to determine whether the update amount of the tool trajectory is less than the threshold;
the output module is configured to output a final tool trajectory M, wave velocity in fluid Vf, and casing's inner surface N.

The beneficial effects of the present invention are as follows: the invention can integrate two sets of ultrasonic measurement methods, fully utilize the arrival time information in the received waveforms, and perform calculations for tool eccentricity, casing's inner surface inversion, and wave velocity in fluid in the pipe string. This further enhances the performance of the ultrasonic logging tool in cased wells, effectively evaluates the geometric parameters (shape and position) and wave velocity in fluid in irregular fluid-filled pipe strings, and simultaneously supports subsequent evaluation of casing cementing quality. It corrects changes in waveform amplitude and phase caused by tool eccentricity, casing deformation, and variations in wave velocity in fluid, thereby improving measurement accuracy and contributing to the evaluation of wellbore integrity.

### BRIEF DESCRIPTION OF THE DRAWINGS

FIG. 1 is a flowchart of the present invention;

FIG. 2 is a schematic diagram of an application and measurement of an ultrasonic logging tool in the present invention;

FIG. 3 is a schematic diagram of an eccentric measurement of an ultrasonic logging tool in a simulated regular pipe string;

FIG. 4 illustrates the predicted results of the tool trajectory, casing's inner surface, and wave velocity in fluid in a simulated regular pipe string;

FIG. 5 illustrates the forward modeling and inversion results of an eccentric measurement of an ultrasonic logging tool in a simulated irregular pipe string;

FIG. 6 is a diagram of the experimental measurement model;

FIG. 7 illustrates the experimental measurement waveforms and the arrival time results extracted from the waveform array using STA/LTA algorithm;

FIG. 8 compares the predicted results and true values of the tool trajectory, pipe string inner boundary, and wave velocity in fluid in the pipe;

FIG. 9 illustrates the pulse-echo data received during one full rotation of the ultrasonic logging tool in a 7-inch experimental well and the pitch-catch experimental data;

FIG. 10 illustrates the predicted results of the tool trajectory, pipe string inner boundary position, and wave velocity in fluid in the 7-inch experimental well;

FIG. 11 illustrates the pulse-echo data received during one full rotation of the ultrasonic logging tool in a 9.625-inch experimental well and the pitch-catch experimental data;

FIG. 12 illustrates the predicted results of the tool trajectory, pipe string inner boundary position, and wave velocity in fluid in the 9.625-inch experimental well.

### DETAILED DESCRIPTION

### Embodiment 1

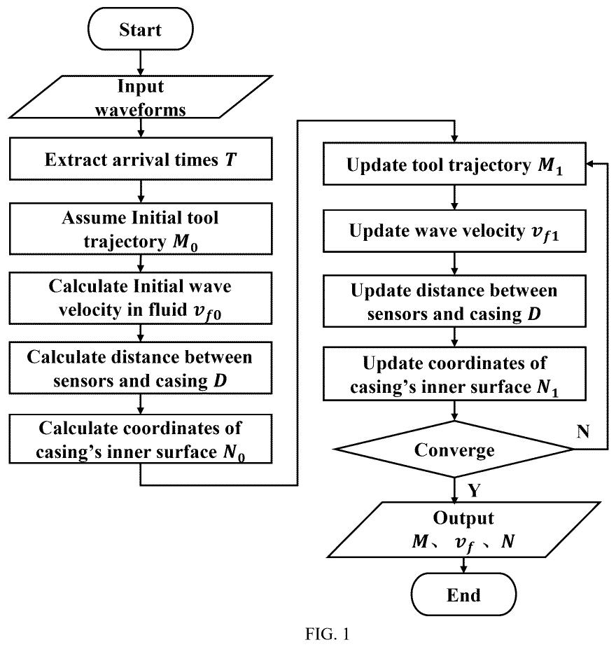

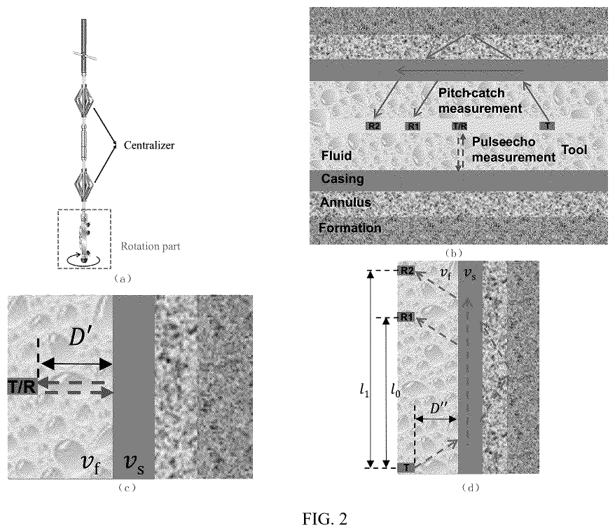

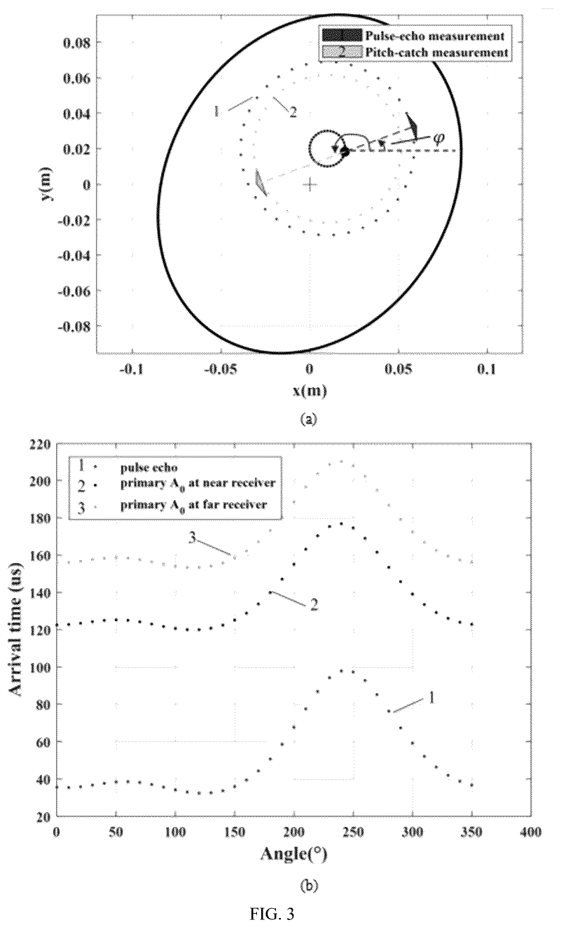

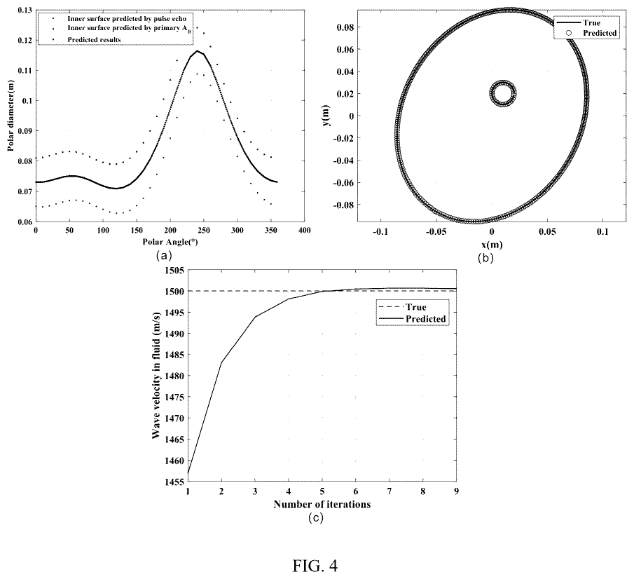

This embodiment presents a case of using numerical simulation methods to simulate the inversion of the tool trajectory, casing's inner surface, and wave velocity in fluid of an ultrasonic logging tool in a regular fluid-filled pipe string (with an elliptical boundary). The figures primarily involved in this embodiment are FIGS. 1 to 4. In FIG. 2: (a) shows the ultrasonic tool section; (b) shows a schematic diagram of the tool measurement process; (c) shows the pulse-echo measurement and distance markings; (d) shows the pitch-catch measurement and distance markings. In FIG. 3: (a) shows a schematic diagram of the ultrasonic logging tool trajectory and casing's inner surface; (b) shows the arrival time of pulse-echo measurement and the arrival time of the primary A₀ at far/near receiver. In FIG. 4: (a) shows the casing's inner surface predicted based on the pulse-echo and the primary A₀; (b) shows the tool trajectory and casing's inner surface predicted by the first iteration; (c) shows the predicted tool trajectory and casing's inner surface after convergence over 7 iterations; (d) shows the changes in the predicted wave velocity in fluid over iterations.

The specific implementation steps are as follows:

Step 1: forward modeling the arrival time of the primary echo in the pulse-echo measurement and the arrival times of primary A₀ at near and far receivers in pitch-catch measurement in a regular fluid-filled pipe string based on the principles of two measurement methods. The specific process is as follows: First, based on the principle of the pulse-echo measurement (FIG. 2c), assuming the wave velocity in fluid in the casing is v_{f}, and the distance between the sensor transmitter and the casing inner wall is D′, the propagation time t_{y} of the reflection echo from the casing inner wall can be expressed as:

$${t}_{V} = 2 {D}^{′} / {v}_{f} ; \qquad \# ( 1 )$$

According to the principle of the pitch-catch measurement (FIG. 2d), the arrival time t_{N} of the primary A₀ detected by the near receiver and the arrival time t_{N} of the primary A₀ detected by the far receiver can be expressed as:

$${t}_{N} = \frac{{l}_{0}}{{v}_{s}} + 2 {D}^{″} \sqrt{\frac{1}{{v}_{f}^{2}} - \frac{1}{{v}_{s}^{2}}} ; \qquad \# ( 2 )$$

$${t}_{F} = \frac{{l}_{1}}{{v}_{s}} + 2 {D}^{″} \sqrt{\frac{1}{{v}_{f}^{2}} - \frac{1}{{v}_{s}^{2}}} ; \qquad \# ( 3 )$$

where l₀ denotes the distance between the transmitter and the near receiver, l₁ denotes the distance between the transmitter and the far receiver, vₛ denotes the propagation velocity of the A₀ flexural wave in the casing, and D″ denotes the distance between the oblique incidence sensor and the casing inner wall.

By combining equations (2) and (3), the propagation velocity vₛ of the A₀ flexural wave in the casing can first be calculated as:

$${v}_{s} = \frac{{l}_{1} - {l}_{0}}{{t}_{F} - {t}_{N}} ; \qquad \# ( 4 )$$

Based on the measurement principles of pulse-echo measurement and pitch-catch measurement, the process of eccentric measurement of an ultrasonic logging tool in a regular fluid-filled pipe string (with elliptical boundary) is simulated using a numerical simulation method (FIG. 3a), where the solid line represents the casing's inner surface, the scattered points depict the tool's trajectory, triangle 1 simulates the pulse-echo probe, and triangle 2 simulates the pitch-catch probe.

The length of the connecting line between the scattered points of the tool's trajectory and the triangular probes represents the sensor size. The angle between the connecting line and the positive direction of the coordinate axis represents the sensor's measurement angle (p). Scattered points 1 represent the sensor positions for 36 pulse-echo measurements, and scattered points 2 represent the sensor positions for 36 pitch-catch measurements. The forward model was used to calculate the of pulse-echo and the arrival time of the primary A₀ T1 (FIG. 3b), where scattered points 1 represent the measured pulse-echo arrival times, scattered points 2 represent the primary A₀ arrival time T21 at the near receiver, and scattered points 3 represent the primary A₀ arrival time T22 at the far receiver.

During the modeling process, a Cartesian coordinate system was established with the center point of the casing's inner surface as the coordinate origin and the direction of the first measurement of the pulse-echo measurement as the positive x-axis direction. The casing's inner surface is set as an ellipse with a major axis length of 0.1 m and a minor axis length of 0.08 m, and rotated 30° counterclockwise. The trajectory of the tool's center is set as a circle with a center x-coordinate of 0.01 m, a center y-coordinate of 0.02 m, and a radius of 0.01 m. The size of the pulse-echo measurement tool (i.e., the distance between the tool's center and the sensor's transmitting end) is set to 0.04 m, and the size of the pitch-catch measurement tool is set to 0.05 m. The initial position of the tool is set at coordinates (0.02 m, 0.02 m). During the measurement process, the tool rotated counterclockwise along its trajectory while simultaneously performing counterclockwise self-rotation measurements, with each rotation increment being 10°, resulting in 36 measurements per full rotation. The initial measurement azimuth for the pulse-echo measurement is set to 0°, and the initial measurement azimuth for the pitch-catch measurement is set to 180°. The acoustic velocity of the fluid inside the casing is set to 1500 m/s, and the propagation velocity of the A₀ flexural wave in the casing is set to 3000 m/s.

Based on the forward modeling of the tool motion process, the distance between the transmitting end of the pulse-echo measurement sensor and the casing's inner surface, as well as the distance between the transmitting end of the pitch-catch measurement sensor and the casing's inner surface, can be calculated. By combining equations (1) to (3), the arrival time of the pulse-echo and the arrival time of the primary A₀ at the far and near receivers can be determined.

Step 2: establishing a Cartesian coordinate system with the center of the casing as the origin and the 0° measurement azimuth of the pulse-echo measurement as the x-axis, assuming that the initial tool trajectory (M₀) is at the coordinate origin.

Step 3: establishing an equation equating the propagation distance of the pulse-echo to the propagation distance of the oblique incidence when the measurement distances of the pulse-echo and the oblique incidence flexural wave are consistent in directions that are 180° apart, and the wave velocity in fluid (Vf₀) at the current depth can be determined using the least squares method.

The detailed description is as follows:

Assuming the initial tool trajectory (M₀) is at the coordinate origin, meaning the tool is fixed at the origin and rotates for measurements. Under this assumption, the sum of the measurement distance of the pulse-echo and the sensor size is equal to the sum of the measurement distance of the pitch-catch and the sensor size in the same measurement direction, that is:

$${D}^{′} ( φ ) + {m}_{0} = {D}^{″} ( φ ) + {m}_{1} ; \qquad \# ( 5 )$$

where φ denotes the sensor measurement azimuth, D′(φ) denotes the measurement distance of the pulse-echo at the measurement azimuth φ, m₀ denotes the pulse-echo sensor size, D″(φ) denotes the measurement distance of the pitch-catch at the measurement azimuth φ, and m₁ denotes the pitch-catch sensor size. Substituting equations (1) and (2) into equation (5) yields:

$${At}_{N} - B = {t}_{V} ; \qquad \# ( 6 )$$

$$wherein , A = \frac{{v}_{s}}{\sqrt{{v}_{s}^{2} - {v}_{f}^{2}}} ; \qquad \# ( 7 )$$

$$B = \frac{{l}_{0}}{\sqrt{{v}_{s}^{2} - {v}_{f}^{2}}} + \frac{2 ( {m}_{0} - {m}_{1} )}{{v}_{f}} ; \qquad \# ( 8 )$$

By substituting the arrival times from 36 measurements into equation (6), a nonlinear overdetermined equation system is obtained. Solving this equation system using the least squares method provides an estimated value for the initial wave velocity in fluid v_{f0}, which is calculated to be 1456.8 m/s.

Step 4: calculating the distance D₀′(φ) between the pulse-echo sensor and the casing inner wall based on T1 and Vf₀ and calculating the distance D₀″(φ) between the pitch-catch sensor and the casing inner wall based on T21, T22, and V_{f0}. The detailed description is as follows: by substituting the estimated wave velocity in fluid v_{f0} into Equation (1), the distance D₀′(φ) between the pulse-echo sensor and the casing's inner surface at any measurement azimuth φ can be determined. Similarly, by substituting the estimated wave velocity in fluid into Equation (2), the distance D₀″(φ) between the pitch-catch sensor and the casing's inner surface at any measurement azimuth φ can be determined.

Step 5: calculating the coordinate set

$${N}_{0}^{′}$$

of the casing's inner surface based on M₀ and D₀′(φ), and calculating the coordinate set

$${N}_{0}^{″}$$

of the casing's inner surface based on M₀ and D₀″(φ); performing interpolation on

$${N}_{0}^{″} and {N}_{0}^{″}$$

according to the azimuth angle, and taking the average of the two boundaries as the estimated casing's inner surface (N₀). The details are as follows: by substituting the estimated wave velocity in fluid v_{f0} into Equation (1), the distance D₀′(φ) between the pulse-echo sensor and the casing's inner surface at any measurement azimuth φ can be determined. Similarly, by substituting the estimated wave velocity in fluid into Equation (2), the distance D₀″(φ) between the pitch-catch sensor and the casing's inner surface at any measurement azimuth φ can be determined. For the pulse-echo measurement, at the measurement azimuth φ, the center coordinate of the tool is M₀(φ). Thus, the coordinates

$${N}_{0}^{′} ( φ )$$

of casing's inner surface at this azimuth can be expressed as:

$${N}_{0}^{′} ( φ ) = {M}_{0} ( φ ) + ( \begin{matrix}cos φ \\ sin φ\end{matrix} ) ( {m}_{0} + {D}_{0}^{′} ( φ ) ) ; \qquad \# ( 9 )$$

Similarly, for the pitch-catch measurement, the casing's inner surface point set

$${N}_{0}^{″}$$

can be estimated using M₀, m₁, and D₀″(φ).

The casing's inner surface point sets

$${N}_{0}^{′} and {N}_{0}^{″}$$

are converted into the polar coordinate system. The polar angles of the two point sets are unified using interpolation, and the average of the polar radii of the two point sets is taken as the estimated polar radius of the casing's inner surface (FIG. 4a). By converting the polar coordinates back to the Cartesian coordinates, the estimated casing's inner surface N₀ is determined.

Step 6: searching for the optimal tool trajectory M₁ starting from the estimated casing's inner surface N₀ that minimizes the mean squared error between the distance between M₁ and N₀ and the measured distances D₀′(φ), D₀″(φ). The detailed description is as follows:

For a specific measurement instance, the pulse-echo measurement azimuth is φ, and the measured distance is D₀′(φ). Move the casing's inner surface N₀ in the direction of φ+π by a distance of D₀′ (φ), retaining the points within the boundary N₀, to obtain the curve M₁′. For the pitch-catch measurement, the measurement azimuth is φ+π, and the measured distance is D₀″(φ). Move the casing's inner surface No the in the direction of φ by a distance of D₀″(φ), retaining the points within the boundary N₀, to obtain the curve M₁″. The intersection of the curves M₁′ and M₁″ is calculated, which represents the tool position at this moment.

Due to errors in the estimation of the boundary and velocity, as well as the fact that the measurement direction in eccentric measurements may not align with the normal direction of the boundary, the curves M₁′ and M₁″ may have no intersection, one intersection, or multiple intersections. When no intersection exists, the midpoint of the closest points between M₁′ and M₁″ is taken as the tool position at this moment. When one intersection exists, the intersection is taken as the tool position at this moment. When multiple intersections exist, all intersection points are potential tool positions, requiring estimation based on tool positions at other measurement azimuths.

By collecting the estimated tool positions from 36 measurement azimuths into a point set A, the trajectory lengths of all possible tool trajectories within A are calculated. The trajectory with the shortest length is identified as the estimated optimal tool trajectory M₁. To enhance search efficiency, the Dijkstra algorithm is used to perform a breadth-first search to determine the final tool trajectory M₁.

Step 7: updating the wave velocity in fluid Vf₁ based on the inverted perimeter of the casing's inner surface N₀, assuming the perimeter of the casing's inner surface remains constant.

Specifically, the wave velocity in fluid estimation method in Step 3 can only be used for the initial estimation of the wave velocity in fluid. When the tool trajectory changes (not at the coordinate origin), the pulse-echo measurement distance D₁′(φ) and the oblique incidence single-shot dual-reception measurement distance D₁″(φ) are no longer equal. A new approach is required to estimate the wave velocity in fluid during the iterative optimization process.

Considering that the perimeter of the casing's inner surface remains nearly constant in actual logging operations, and that the dimensions of the casing (outer diameter and thickness) for the current measurement well section can be obtained, a constraint on the perimeter of the casing's inner surface is added. The wave velocity in fluid is then updated based on the predicted perimeter of the casing's inner surface as follows:

$${v}_{f 1} = \frac{{c}_{true}}{{c}_{0}} \times {v}_{f 0} ; \qquad \# ( 11 )$$

where c₀ denotes the perimeter of boundary N₀ or the perimeter of the ellipse fitted to N₀, and cₜᵣᵤₑ denotes the perimeter of the casing's inner surface calculated based on the casing dimensions. v_{f0} is the wave velocity in fluid before the update, and v_{f1} is the wave velocity in fluid after the update. According to the new wave velocity in fluid calculation strategy, the variation curve of the wave velocity in fluid during the iteration process is shown in FIG. 4c, gradually converging toward the target value.

Step 8: calculating the distance D₁′(φ) between the pulse-echo sensor and the casing inner wall based on T1 and Vf1; and calculating the distance D₁″(φ) between the pitch-catch sensor and the casing inner wall based on T21, T22, and Vf1.

Step 9: calculating the casing's inner surface coordinate set N₁′ based on M₁ and D₁″(φ); calculating the casing's inner surface coordinate set N₁″ based on M₁ and D₁″(φ). Perform interpolation on N₁′ and N₁″ according to the azimuth angle, respectively, and take the average of the two boundaries as the estimated casing's inner surface N₁.

Step 10: repeating steps 6 to 9 until the update amount of the tool trajectory between two iterations is less than a threshold. The specific steps are as follows: iteratively optimizing the casing's inner surface, tool trajectory, and wave velocity in fluid until the tool trajectory converges, i.e., the sum of the Manhattan distances of the coordinate changes in the tool trajectory between two iteration steps is less than a given threshold ρ. When ρ=10⁻³ m, the iteration stops after 10 cycles. The final inversion result is shown in FIG. 4b, where the estimated casing's inner surface closely matches the forward model, with a root mean square error (RMSE) of 1.34×10⁻⁴. The tool trajectory closely matches the forward model, with an RMSE of 1.66×10⁻⁴. The updated wave velocity in fluid curve is shown in FIG. 4c. The final estimated wave velocity in fluid is 1500.56 m/s, with a relative error of 0.036% compared to the wave velocity in fluid of 1500 m/s in the forward model.

Step 11: outputting the final tool trajectory M, wave velocity in fluid V_{f}, and casing's inner surface N.

### Embodiment 2

This embodiment presents a case of using numerical simulation methods to simulate the inversion of the tool trajectory, casing's inner surface, and wave velocity in fluid of an ultrasonic logging tool in an irregular fluid-filled pipe string. The primary figure associated with this embodiment is FIG. 5, wherein (a) shows the trajectory of the ultrasonic logging tool and the casing's inner surface; (b) shows the arrival time of the pulse-echo measurement and the arrival time of primary A₀ at the far/near receivers; (c) shows the predicted tool trajectory and the casing's inner surface after convergence over 9 iterations; and (d) shows the changes in the predicted wave velocity in fluid over the iterations.

The specific implementation steps are as follows:

Step 1: forward modeling the arrival time of the primary echo in the pulse-echo measurement and the arrival times of the primary A₀ at the near and far receivers in pitch-catch measurement in an irregular fluid-filled pipe string based on the principles of two measurement methods. The specific process is as follows: The measurement process of the ultrasonic logging tool moving along an irregular trajectory in the irregular fluid-filled pipe string is forward-modeled (FIG. 5a). The casing's inner surface is shown as the solid line in FIG. 5a, and the tool trajectory is represented by the scattered points in FIG. 5a. The given wave velocity in fluid is 1600 m/s, and the propagation velocity of the A₀ mode wave in the casing is 3000 m/s. The pulse-echo arrival time and the oblique incidence primary A₀ arrival time are shown in FIG. 5b.

Step 2: establishing a Cartesian coordinate system with the center of the casing as the origin and the 0° measurement azimuth of the pulse-echo measurement as the x-axis, assuming that the initial tool trajectory (M₀) is at the coordinate origin.

Step 3: establishing an equation equating the propagation distance of the pulse-echo to the propagation distance of the oblique incidence when the measurement distances of the pulse-echo and the oblique incidence flexural wave are consistent in directions that are 180° apart, and the wave velocity in fluid (Vf₀) at the current depth can be determined using the least squares method.

Step 4: calculating the distance D₀′(φ) between the pulse-echo sensor and the casing inner wall based on T1 and Vf₀ and calculating the distance D₀″(φ) between the pitch-catch sensor and the casing inner wall based on T21, T22, and Vf₀.

Step 5: calculating the coordinate set

$${N}_{0}^{′}$$

of the casing's inner surface based on M₀ and D₀′(φ), and calculating the coordinate set

$${N}_{0}^{″}$$

of the casing's inner surface based on M₀ and D₀″(φ); performing interpolation on

$${N}_{0}^{″} and {N}_{0}^{″}$$

according to the azimuth angle, and taking the average of the two boundaries as the estimated casing's inner surface (N₀).

Step 6: based on the distance D and the coordinates of casing's inner surface N₀, and searching for the optimal tool trajectory M₁, to make the shortest trajectory.

Step 7: updating the wave velocity in fluid Vf₁ based on the inverted perimeter of the casing's inner surface N₀ or the perimeter of an ellipse fitted to N₀, assuming the perimeter of the casing's inner surface remains constant.

Step 8: calculating the distance D₁′(φ) between the pulse-echo sensor and the casing inner wall based on T1 and Vf1; and calculating the distance D₁″(φ) between the pitch-catch sensor and the casing inner wall based on T21, T22, and Vf1.

Step 9: calculating the casing's inner surface coordinate set N₁′ based on M₁ and D₁′(φ); calculating the casing's inner surface coordinate set N₁″ based on M₁ and D₁″(φ). Perform interpolation on N₁′ and N₁″ according to the azimuth angle, respectively, and take the average of the two boundaries as the estimated casing's inner surface N₁.

Step 10: repeating steps 6 to 9 until the update amount of the tool trajectory between two iterations is less than a threshold.

Step 11: outputting the final tool trajectory M, wave velocity in fluid Vf, and casing's inner surface N.

The specific results are as follows: Based on the arrival time of the pulse-echo and the arrival times of the primary A₀ at the near and far receivers, the tool trajectory, casing's inner surface, and wave velocity in fluid in the casing were inverted using the iterative optimization algorithm proposed in this invention. The final inversion results are shown in FIGS. 5c and 5d. The inverted casing's inner surface closely matches the forward model, but deviations still exist at abrupt changes, which are caused by the insufficient circumferential resolution of the tool measurements. The root mean square error (RMSE) between the predicted casing's inner surface and the true boundary is 7.69×10⁻⁴. The tool exhibits irregular motion, and the predicted results closely match the true trajectory. The RMSE between the predicted and true tool trajectories is 9.70×10⁻⁴. The estimation of the wave velocity in fluid converges stably under the constraint of the casing's inner surface perimeter. The final predicted wave velocity in fluid in the casing is 1609.8 m/s, with a relative error of 0.61% compared to the given wave velocity in fluid of 1600 m/s in the forward model.

### Embodiment 3

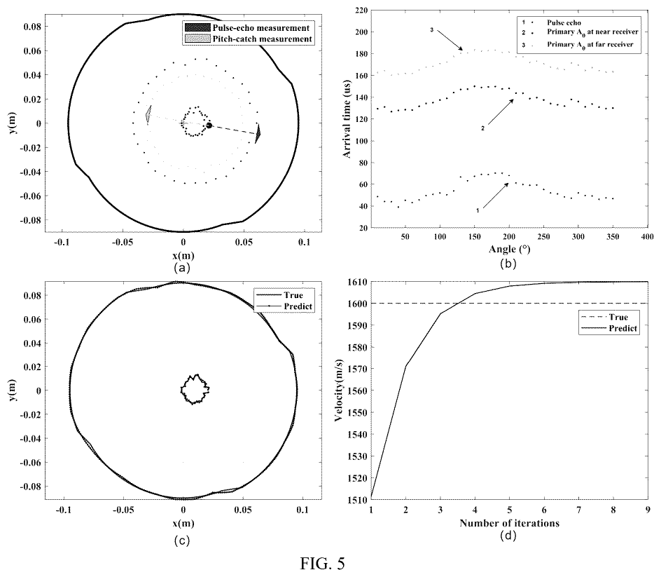

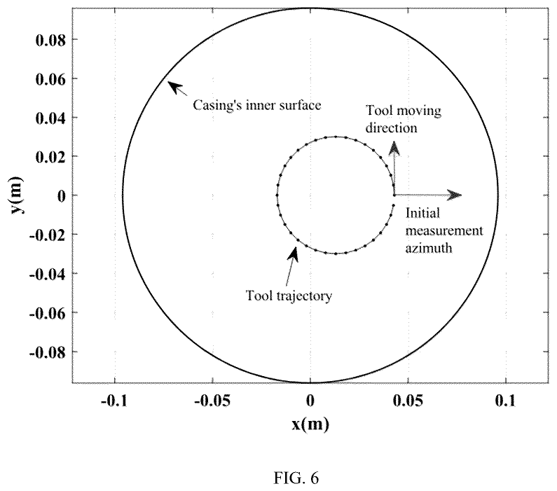

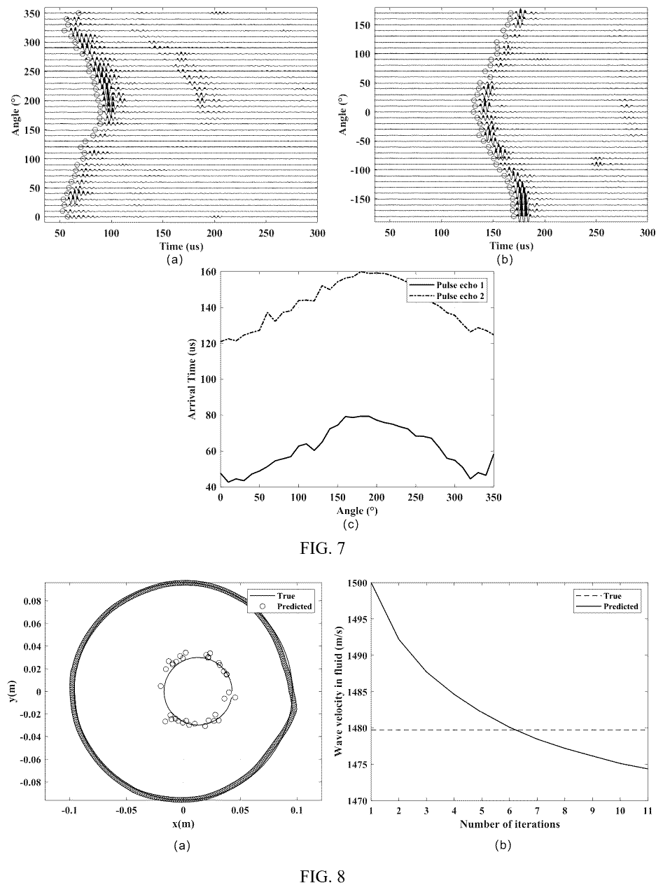

This embodiment presents a case validated through laboratory measurements, primarily involving FIGS. 6 to 8, where FIG. 6 shows the experimental measurement model. In FIG. 7, (a) shows the pulse-echo waveform and the extracted arrival time result measured at azimuth φ; (b) shows the pulse-echo waveform and the extracted arrival time result measured at azimuth φ+180°; and (c) presents a summary of the extracted arrival time results from two sets of pulse-echo measurements in opposite directions. In FIG. 8, (a) shows the comparison of the predicted tool trajectory and pipe string inner boundary with the true values; (b) shows the comparison of the predicted wave velocity in fluid with the true value over the number of iterations.

The specific steps are as follows:

Step 1: an experimental measurement platform is set up, and measurement is conducted following the measurement trajectory shown in FIG. 6. The arrival time of primary echo in pulse-echo is extracted from the obtained waveform array. The details are as follows:

This measurement uses three stepper motors to control the X-axis motion, Y-axis motion, and rotational motion of the ultrasonic tool, respectively. The motion states of the motors are controlled by a host computer. A 250 kHz broadband ultrasonic transducer with a length of 25 mm is used as the acoustic source. Afunction generator is used to produce a 250 kHz sinusoidal excitation signal, and a virtual digital oscilloscope is used to receive the waveform signals. A PVC pipe with an outer diameter of 0.2 m and a thickness of 4 mm is used to simulate the casing. Pulse-echo measurement is used instead of pitch-catch measurement. Specifically, the pulse-echo waveform data at azimuth φ and azimuth φ-180° are collected at each measurement position. The experimental model setup is shown in FIG. 6. The solid line represents the inner boundary, with an inner boundary radius of 96 mm and a center at the coordinate origin. The tool trajectory is circular, with a center at (13 mm, 0 mm) and a radius of 30 mm. The initial measurement direction of the tool is the positive x-axis direction. It undergoes counterclockwise rotational displacement along the trajectory, while the tool itself rotates 100 each time.

The waveform array obtained from the pulse-echo measurement at azimuth φ is shown in FIG. 7a, and the waveform array obtained from the pulse-echo measurement at azimuth φ-180° is shown in FIG. 7b. The arrival time of the pulse-echo is extracted using the STA/LTA algorithm, with a short window length set to 10 microseconds and a long window length set to 50 microseconds. The extracted arrival time results are shown in FIGS. 7a and 7b, where the extracted arrival time results closely match the onset points of the pulse-echo. The two sets of arrival time data are arranged within the angular range of [0°, 360°), as shown in FIG. 7c. This enables the iterative optimization algorithm proposed in this disclosure to be applied for tool positioning, casing's inner surface inversion, and wave velocity in fluid estimation.

Step 2: establishing a Cartesian coordinate system with the center of the casing as the origin and the 0° measurement azimuth of the pulse-echo measurement as the x-axis, assuming that the initial tool trajectory (M₀) is at the coordinate origin.

Step 3: establishing an equation equating the propagation distance of the pulse-echo to the propagation distance of the oblique incidence when the measurement distances of the pulse-echo and the oblique incidence flexural wave are consistent in directions that are 1800 apart, and the wave velocity in fluid (Vf₀) at the current depth can be determined using the least squares method.

Step 4: calculating the distance D₀′(φ) between the pulse-echo sensor and the casing inner wall based on T1 and Vf₀ and calculating the distance D₀″(φ) between the pitch-catch sensor and the casing inner wall based on T21, T22, and Vf₀.

Step 5: calculating the coordinate set

$${N}_{0}^{′}$$

of the casing's inner surface based on M₀ and D₀′(φ), and calculating the coordinate set

$${N}_{0}^{″}$$

of the casing's inner surface based on M₀ and D₀″(φ); performing interpolation on

$${N}_{0}^{″} and {N}_{0}^{″}$$

according to the azimuth angle, and taking the average of the two boundaries as the estimated casing's inner surface (N₀).

Step 6: based on the distance D and the coordinates of casing's inner surface N₀, and searching for the optimal tool trajectory M₁, to make the shortest trajectory.

Step 7: updating the wave velocity in fluid Vf₁ based on the inverted perimeter of the casing's inner surface No or the perimeter of an ellipse fitted to N₀, assuming the perimeter of the casing's inner surface remains constant.

Step 8: calculating the distance D₁′(φ) between the pulse-echo sensor and the casing inner wall based on T1 and Vf1; and calculating the distance D₁″(φ) between the pitch-catch sensor and the casing inner wall based on T21, T22, and Vf1.

Step 9: calculating the casing's inner surface coordinate set N₁′ based on M₁ and D₁′(φ); calculating the casing's inner surface coordinate set N₁″ based on M₁ and D₁″(φ). Perform interpolation on N₁′ and N₁″ according to the azimuth angle, respectively, and take the average of the two boundaries as the estimated casing's inner surface N₁.

Step 10: repeating steps 6 to 9 until the update amount of the tool trajectory between two iterations is less than a threshold.

Step 11: outputting the final tool trajectory M, wave velocity in fluid Vf, and casing's inner surface N.

The specific results are as follows: Using the two sets of arrival times for iterative optimization inversion, the termination condition is met after 11 iterations. The final inversion results of the inner boundary and tool trajectory are shown in FIG. 8a, which closely match the experimental model. The root mean square error (RMSE) between the predicted inner boundary and the true value is 9.27×10⁻⁴, and the RMSE between the predicted tool trajectory and the true value is 1.29×10⁻². The estimated wave velocity in fluid is shown in FIG. 8b.

To obtain the true wave velocity in fluid, two 250 kHz ultrasonic transducers are placed at both ends of a water tank for a single transmission and reception measurement, with a distance of 21.5 cm between the transmitting ends of the two transducers. The extracted arrival time from the waveform is 145.3 microseconds, resulting in a calculated ultrasonic propagation velocity in the fluid of 1479.7 m/s. The final predicted wave velocity in fluid is 1475.57 m/s, with a relative error of 0.28% compared to the experimentally measured wave velocity in fluid of 1479.7 m/s.

### Embodiment 4

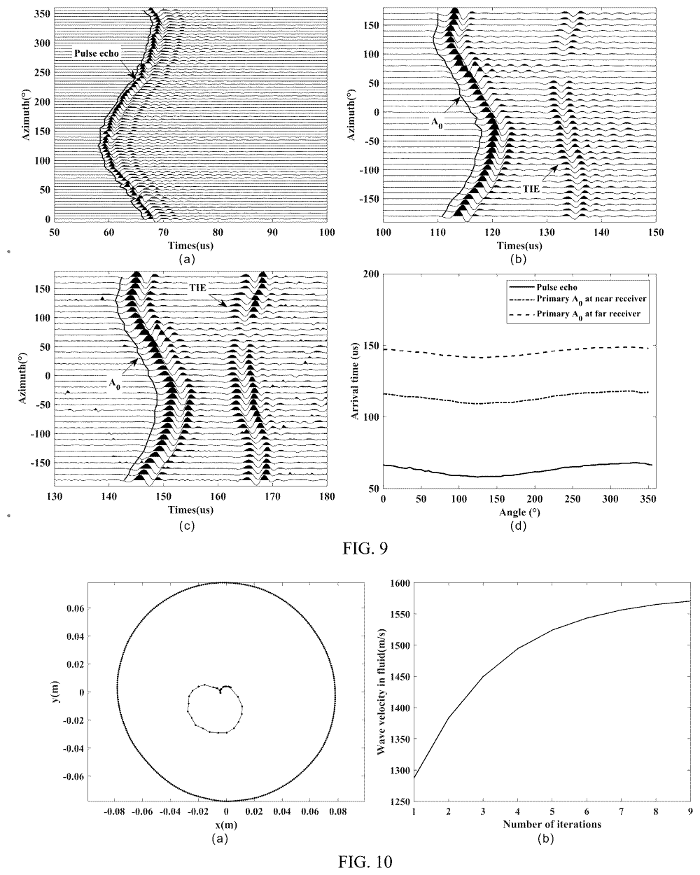

This embodiment presents the pulse-echo data and pitch-catch experimental data received by an ultrasonic measurement tool during a full rotation in a 7-inch experimental well. This embodiment primarily involves FIGS. 9 to 10. In FIG. 9, (a) shows the pulse-echo measurement waveform and the extracted pulse-echo arrival time; (b) shows the waveform array received by the near receiver in the pitch-catch measurement and the extracted arrival time of the primary A₀; (c) shows the waveform array received by the far receiver in the pitch-catch measurement and the extracted arrival time of the primary A₀; and (d) shows the arrival time of the pulse-echo and the arrival time of the primary A₀ summarized in a single window. In FIG. 10, (a) shows the tool trajectory and pipe string inner boundary; (b) shows the predicted wave velocity in fluid results over the number of iterations.

The circumferential resolution of the pulse-echo measurement is 5°, resulting in a total of 72 waveforms per full rotation (FIG. 9a). The circumferential resolution of the pitch-catch measurement is 10°, resulting in a total of 36 waveforms per full rotation (FIG. 9b for the near receiver waveforms and FIG. 9c for the far receiver waveforms). The arrival times are extracted using the STA/LTA algorithm, with a short window length set to 10 microseconds and a long window length set to 50 microseconds. FIG. 9 shows the extracted arrival time results, where the extracted arrival times closely match the onset points of the pulse-echo and the primary A₀. The arrival times are summarized in FIG. 9d. Based on the extracted arrival times, tool positioning, casing's inner surface inversion, and wave velocity in fluid estimation are performed, with the inversion results shown in FIG. 10. From the inversion results, it can be observed that the casing's inner surface is approximately circular, closely matching the dimensions of the casing used during the well construction. However, significant tool eccentricity is present (the dashed line in FIG. 10a represents the tool's center trajectory), which is related to the absence of a centralizer during measurement. The final predicted wave velocity in fluid is 1576.6 m/s, showing some deviation from the acoustic velocity of water filled in the casing during well construction. However, considering the possible presence of sediment mixed in the water, the final predicted acoustic velocity falls within an acceptable range.

### Embodiment 5

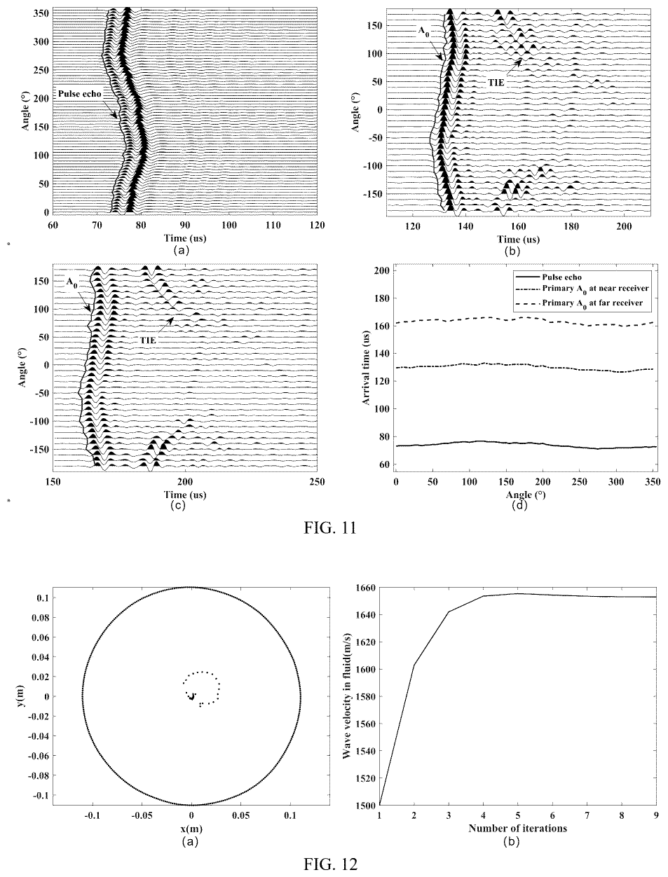

This embodiment presents a case where an ultrasonic measurement tool rotated one full cycle in a 9.625-inch field well, receiving pulse-echo data and pitch-catch data. Compared to the first field measurement case, the measurements in this embodiment are more standardized. This embodiment primarily involves FIGS. 11 to 12. In FIG. 11, (a) shows the pulse-echo measurement waveform and the extracted arrival time of the pulse-echo; (b) shows the waveform array received by the near receiver in the pitch-catch measurement and the extracted arrival time of the primary A₀; (c) shows the waveform array received by the far receiver in the pitch-catch measurement and the extracted arrival time of the primary A₀; and (d) shows the arrival time of the pulse-echo and the arrival time of the primary A₀ summarized in a single window. In FIG. 12, (a) shows the tool trajectory and pipe string inner boundary; (b) shows the predicted wave velocity in fluid results over the number of iterations.

The circumferential resolution of the pulse-echo measurement is 5°, resulting in a total of 72 waveforms per full rotation (FIG. 11a). The circumferential resolution of the pitch-catch measurement is 10°, resulting in a total of 36 waveforms per full rotation (FIG. 11b for the near receiver waveforms and FIG. 11c for the far receiver waveforms). The arrival times are extracted using the STA/LTA algorithm, and the extraction results are represented by solid lines on the waveform arrays, which are finally summarized in FIG. 1id. Based on the extracted arrival times, tool positioning, casing's inner surface inversion, and wave velocity in fluid estimation are performed, with the inversion results shown in FIG. 12. From the inversion results, it can be observed that the casing's inner surface is standard circle, indicating no deformation of the casing, and its dimensions closely match the well construction model. Due to the more standardized measurement process (using a centralizer to maintain centralized measurements), the tool center remains near the center of the casing. The final predicted wave velocity in fluid is 1652.7 m/s, which is slightly higher than the acoustic velocity in water. This is speculated to be related to changes in downhole temperature and pressure. The final prediction results validate the standardization of the measurement process and provide reliable recommendations for subsequent cement evaluation outside the casing.

### Embodiment 6

A system for positioning a trajectory of an ultrasonic logging tool is provided to implement the method for positioning the trajectory of the ultrasonic logging tool described above. The system includes an input module, an initialization module, a calculation module, an optimization module, a determination module, and an output module, wherein:

Input module: configured to input a waveform array and extract a waveform arrival time T.

Initialization module: configured to establish a coordinate system and initialize the tool trajectory M₀.

Calculation module: configured to calculate the initial wave velocity in fluid Vf₀ using the least squares method and calculate the distance D between the tool and the casing and the coordinates of casing's inner surface No based on the initial wave velocity in fluid Vf₀ and time T.

Optimization module: configured to search for the optimal tool trajectory M₁ starting from M₀, and update the wave velocity in fluid Vf₁, the distance D′ between the tool and the casing, and the coordinates of casing's inner surface N₁ based on the distance between M₁ and N₀.

Determination module: configured to determine whether the update amount of the tool trajectory is less than a threshold.

Output module: configured to output the final tool trajectory M, wave velocity in fluid V_{f}, and casing's inner surface N.

Based on the above embodiments, the present invention has at least the following technical advantages: The invention combines two ultrasonic measurement methods to fully utilize the arrival time information in the received waveforms, enabling tool eccentricity calculation, casing's inner surface inversion, and the estimation of the wave velocity in fluid in the pipe string. This further enhances the performance of ultrasonic logging tools in cased wells, effectively evaluates geometric parameters (shape and position) and wave velocity in fluid in irregular fluid-filled pipe strings, and supports subsequent casing cementing quality evaluation. It corrects waveform amplitude and phase variations caused by tool eccentricity, casing deformation, and wave velocity in fluid changes, improving measurement accuracy and contributing to wellbore integrity evaluation.

1. A method for positioning a trajectory of an ultrasonic logging tool, comprising the following steps:
S1: inputting waveforms and extracting arrival times T;
S2: establishing a coordinate system and initializing a tool trajectory M₀;
S3: calculating an initial wave velocity in fluid Vf₀ using a least squares method, and calculating a distance D between the tool and a casing and coordinates of casing's inner surface N₀ based on the initial wave velocity in fluid Vf₀ and time T;
S4: searching for an optimal tool trajectory M₁ based on the distance D and the inner boundary coordinates N₀, updating a wave velocity in fluid Vf₁ according to a perimeter of the inner boundary N₀, and updating a distance D between the tool and the casing and coordinates of casing's inner surface N₁ based on Vf₁ and time T;
S5: repeating step S4 until the update amount of the tool trajectory between two iterations is less than a threshold;
S6: outputting a final tool trajectory M, wave velocity in fluid V_{f}, and casing's inner surface N.

2. The method for positioning the trajectory of the ultrasonic logging tool according to claim 1, wherein step S1 comprises the following sub-steps:
S11: inputting a pulse-echo measurement waveform and a pitch-catch measurement waveform;
S12: extracting an arrival time T1 of the primary echo of the pulse-echo and arrival times T21 and T22 of the primary A₀ at near receiver and far receiver, respectively, using a long-short time window algorithm.

3. The method for positioning the trajectory of the ultrasonic logging tool according to claim 2, wherein step S2 specifically comprises: establishing a Cartesian coordinate system with a casing center as an origin and a 0° measurement azimuth of the pulse-echo as an x-axis, and initializing the tool trajectory M₀ as the coordinate origin.

4. The method for positioning the trajectory of the ultrasonic logging tool according to claim 3, wherein step S3 comprises the following sub-steps:
S31: establishing a computational model for a propagation distance of the pulse-echo and a propagation distance of the oblique incidence, and solving for the wave velocity in fluid Vf₀ at a current depth using the least squares method;
S32: calculating a distance D₀′ between a pulse-echo sensor and a casing inner wall based on T1 and Vf₀; calculating a distance D₀″ between a pitch-catch sensor and the casing inner wall based on T21, T22 and Vf₀;
S33: calculating the casing's inner surface No based on M₀, D₀′ and D₀″.

5. The method for positioning the trajectory of the ultrasonic logging tool according to claim 4, wherein step S33 specifically comprises: calculating a casing's inner surface coordinate set N₀′ based on M₀ and D₀′; calculating a casing's inner surface coordinate set N₀″ based on M₀ and D₀″; interpolating N₀′ and N₀″ according to an azimuth angle, respectively, and taking an average of the two boundaries as an estimated casing's inner surface No.

6. The method for positioning the trajectory of the ultrasonic logging tool according to claim 5, wherein step S4 comprises the following sub-steps:
S41: calculating all possible positions of the tool based on the distance D and the coordinates of casing's inner surface N₀, and searching for the shortest trajectory as the optimal tool trajectory M₁;
S42: updating the wave velocity in fluid Vf₁ based on a perimeter of the inverted casing's inner surface N₀ or a perimeter of an ellipse fitted to N₀;
S43: calculating a distance D₁′ between the pulse-echo sensor and the casing inner wall based on T1 and V_{f1}; calculating a distance D₁″ between the pitch-catch sensor and the casing inner wall based on T21, T22 and Vf₁;
S44: calculating the casing's inner surface N₁ based on M₁, D₁′ and D₁″.

7. The method for positioning the trajectory of the ultrasonic logging tool according to claim 6, wherein step S44 specifically comprises: calculating a casing's inner surface coordinate set N₁′ based on M₁ and D₁′; calculating a casing's inner surface coordinate set N₁″ based on M₁ and D₁″; interpolating N₁′ and N₁″according to the azimuth angle, respectively, and taking an average of the two boundaries as an estimated casing's inner surface N₁.

8. The method for positioning the trajectory of the ultrasonic logging tool according to claim 7, wherein step S6 specifically comprises: repeating step S4, iteratively updating the tool trajectory, determining an error between the updated tool trajectory and an original tool trajectory, terminating iteration when the error is less than the threshold, and outputting the tool trajectory M, the wave velocity in fluid V_{f} and the casing's inner surface N.

9. A system for positioning a trajectory of an ultrasonic logging tool, configured to implement the method for positioning the trajectory of the ultrasonic logging tool according to claim 1, comprising an input module, an initialization module, a calculation module, an optimization module, a determination module, and an output module, wherein:
the input module is configured to input a waveform array and extract a waveform arrival time T;
the initialization module is configured to establish a coordinate system and initialize a tool trajectory M₀;
the calculation module is configured to calculate an initial wave velocity in fluid Vf₀ using a least squares method, and calculate a distance D between the tool and a casing and coordinates of casing's inner surface N₀ based on the initial wave velocity in fluid Vf₀ and time T;
the optimization module is configured to, starting from M₀, search for an optimal tool trajectory M₁, and update a wave velocity in fluid Vf₁, a distance D′ between the tool and the casing, and the coordinates of casing's inner surface N₁ based on a distance between M₁ and N₀;
the determination module is configured to determine whether the update amount of the tool trajectory is less than the threshold;
the output module is configured to output a final tool trajectory M, wave velocity in fluid V_{f}, and casing's inner surface N.
